(19) United States
(12) Patent Application Publication
(10) Pub. No.: US 2024/0095578 A1
(43) Pub. Date: Mar. 21, 2024

(54) FIRST-ORDER UNADVERSARIAL DATA GENERATION ENGINE

(71) Applicant: GM Cruise Holdings LLC, San Francisco, CA (US)

(72) Inventors: Zhao Chen, Mountain View, CA (US); Yuning Chai, San Mateo, CA (US)

(21) Appl. No.: 17/947,796

(22) Filed: Sep. 19, 2022

(51) Int. Cl. G06N 20/00; B60W 50/06; B60W 60/00

(52) U.S. Cl. CPC G06N 20/00; B60W 50/06; B60W 60/0015

(57) ABSTRACT

The disclosed technology provides solutions for generating synthetic driving scenes and in particular, for generating driving scenes with reduced safety metrics for use in testing and/or training various systems of an autonomous vehicle (AV). A method of the disclosed technology can include steps for receiving, at an encoding model, driving data representative of a first driving scene, wherein the encoding model is configured to generate a first set of feature vectors based on the driving data, processing the first set of feature vectors to generate a second set of feature vectors, and processing the second set of feature vectors to generate a second driving scene. Systems and machine-readable media are also provided.

### BACKGROUND

### 1. Technical Field

The disclosed technology provides solutions for generating synthetic driving scenes and in particular, for generating driving scenes with reduced safety metrics for use in testing and/or training various systems of an autonomous vehicle (AV).

### 2. Introduction

Autonomous vehicles (AVs) are vehicles having computers and control systems that perform driving and navigation tasks that are conventionally performed by a human driver. As AV technologies continue to advance, they will be increasingly used to improve transportation efficiency and safety. As such, AVs will need to perform many of the functions that are conventionally performed by human drivers. Such tasks may require the collection and processing of large quantities of data using various sensor types, including but not limited to cameras and/or Light Detection and Ranging (LiDAR) sensors disposed on the AV. In some instances, the collected data can be used by the AV to perform tasks relating to routing, planning and obstacle avoidance. To ensure safe and efficient operation these various AV systems can require extensive testing and training.

### BRIEF DESCRIPTION OF THE DRAWINGS

Certain features of the subject technology are set forth in the appended claims. However, the accompanying drawings, which are included to provide further understanding, illustrate disclosed aspects and together with the description explain the principles of the subject technology. In the drawings:

FIG. 1 illustrates a simplified block diagram of an example data generation engine, according to some aspects of the disclosed technology.

FIG. 2 illustrates a block diagram of an example task processor configured to facilitate the generation of synthetic driving scenarios, according to some aspects of the disclosed technology.

FIG. 3 illustrates a flow diagram of an example process for performing synthetic scene generation, according to some aspects of the disclosed technology.

FIG. 4 illustrates an example architecture of a machine-learning model, according to some aspects of the disclosed technology.

FIG. 5 illustrates an example system environment that can be used to facilitate AV dispatch and operations, according to some aspects of the disclosed technology.

FIG. 6 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring certain concepts.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

The training of machine-learning models is often encumbered by a lack of data for certain cases, i.e., rare/edge cases. Furthermore, edge cases can often be difficult to train due to high data-dimensionality, which can render the data vulnerable to overfitting and adversarial attacks, and make them difficult to interpret by human practitioners. For safety critical use-cases, such as autonomous driving and other robotics applications, these difficulties pose fundamental obstacles to the practical use of neural networks. For example, an autonomous vehicle (AV) collecting on-road data (also: driving data or vehicle data) in even challenging urban environments is unlikely to encounter any safety-critical events; the vast majority of data collected corresponding to “normal” road conditions and “normal” behaviors from typical traffic participants, such as other vehicles and pedestrians.

Aspects of the disclosed technology provide solutions for generating edge-case scenarios (data) that are of relevance to a given machine-learning (ML) model, i.e., those data that are of practical use for improving the robustness and/or accuracy of model performance. For example, some aspects of the disclose technology provide solutions for generating novel (edge-case) driving scenes (also: synthetic scenarios) that can be used for training and/or testing various AV systems. Although several aspects of this disclosure contemplate novel ML processing architectures in the context AV applications, those of skill in the art will recognize that the aspects disclosed herein can relate to other use-cases. By way of example, the disclosed solutions can be applied to classification tasks, e.g., for the generation of data that describe rare classes (e.g., images of high uncertainty, in the case of image classification) for model stress testing.

In some approaches, model-driven data generation can be performed using gradients that are backpropagated to move the input data in a direction specified by some model's pre-defined task. In the AV context, the task (or goal) may be the generation of synthetic scenes with reduced/lower associated safety scores. For example, data generation may include the generation of synthetic scenes that include entities that exhibit rare and/or dangerous behaviors. In the context of image classification, the task may be the generation of data (or transmutation of input data) into a form that represents different or rarely occurring/lesser-trained classification categories. In both examples, gradients can be calculated with respect to the desired task/objective and with respect to one or more feature vectors (or deep features), to facilitate the generation of new examples.

Some advantages to using task-gradients in adversarial data generation include the flexibility granted by the ubiquity of gradients (generally) within neural network training, and that task-gradients can be used to facilitate adversarial data generation without significant changes to forward-pass ML architectures.

One parallel approach to data generation that has achieved significant popularity is the use of Generative Adversarial Networks (GANs), which generate data from latent noise vectors and validate the generated data's distribution through a downstream discriminator model. Despite their ubiquity within deep learning literature, GANs are typically a poor solution to the problem of synthetic scene generation for AV testing/training. For one, their outputs are not transformations of an input example, but rather generated based on random noise; this makes their outputs difficult to tune and means significant engineering and architectural design are typically required to improve interpretability of the latent space and/or tunability of specific attributes of the output.

Aspects of the disclosed technology provide approaches that entail taming the simple elegance of gradient perturbative methods with the generative machinery of GANs. To do so, a deep feature layer H is selected within a standard base model, or encoder, F^{(enc)} that performs a task of interest with output y. A decoder branch F^{(dec)} is then to H. Gradients can be calculated of some output desiderata y′ (for example, high prediction uncertainty or a desired semantic class) with respect to the autoencoder branch input, resulting in new features H′. By acting on the latent feature space rather than on the inputs directly, there is significantly more control over regularization and dimensionality, and the limitations that conventionally lead to adversarial example generation can be overcome. In some approaches, an autoencoder loss to output F^{(dec)}(H) can then be added, and both F^{(dec)}(H) and F^{(dec)}(H′) can be sent through a separate discriminator model F^{(disc)}.

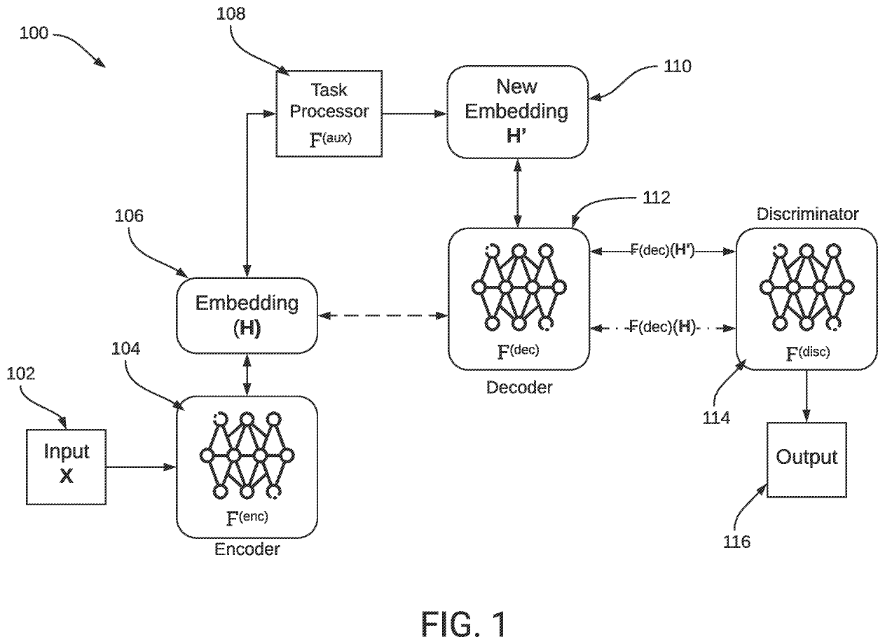

FIG. 1 illustrates a simplified block diagram of an example data generation engine 100, according to some aspects of the disclosed technology. Training of data generation engine 100 can entail the training of four separate models e.g., an encoder model F^{(enc)} 104, a task (or task-gradient) model F^{(aux)} 108, a decoding model F^{(dec)} 112, and a discriminator model F^{(disc)} 114. Each of the four models can be trained in tandem on data input X, e.g., input 102, output task y, and desired output \tilde{y}, for example, according to the relationship of equation (1)

| | | | |
|---|---|---|---|
| H = F^{(enc)}(X), | ŷ = F^{(enc)}(H), | \hat{X} = F^{(dec)}(H) | (1) |

The features (or feature embeddings) of tensor H can be iteratively altered so that the output y changes toward a desired output \tilde{y} in the standard gradient (∇) direction for T steps, according to the relation of equation 2:

HₜHₜ₋₁+λₜ₋₁Gₜ₋₁;Gₜ:=Σ((\tilde{y}−\hat{y})·∇_{H}_{ₜ}( [symbol] (Hₜ)));H₀:=H;H′:=H_{T} (2)

where the sum is taken over the output dimensions. During training T can be chosen as a random integer in the range [1, Tₘₐₓ] to ensure model exposure to in-between states. The learning rate λₜ can also be tuned so that at the end of the iterative process, the predicted ŷ based on Hₜ is precisely the desired \tilde{y}. Once feature vector H′ has been transformed (resulting in new embedding 110), everything can be decoded using decoder 112, and validated using discriminator 114, resulting in output 116.

In practice, input 102 can represent driving data (or driving scene data) that has been collected by an autonomous vehicle (AV), via one or more AV sensors. By way of example, the AV sensors can include, but are not limited to, one or more Light Detection and Ranging (LiDAR) sensors, radar sensors, cameras, Inertial Measurement Units (IMUs), and the like. As such, the driving data can describe a scene (e.g., a first driving scene) encountered by the AV, including various entities (e.g., objects, vehicles, pedestrians, etc.) detected by the AV sensors. The first driving scene can be associated with a semantic classification, such as a safety score that provides a qualitative indicator of the difficulty of the scene for one or more driving operations performed by the AV. The (input) driving data 102 can then be provided to an encoder model 104 that can include (or can be) a deep learning neural network. In turn, encoder model 104 can generate one or more feature vectors (also: feature embeddings H) 106, that represent deep features of input driving data 102.

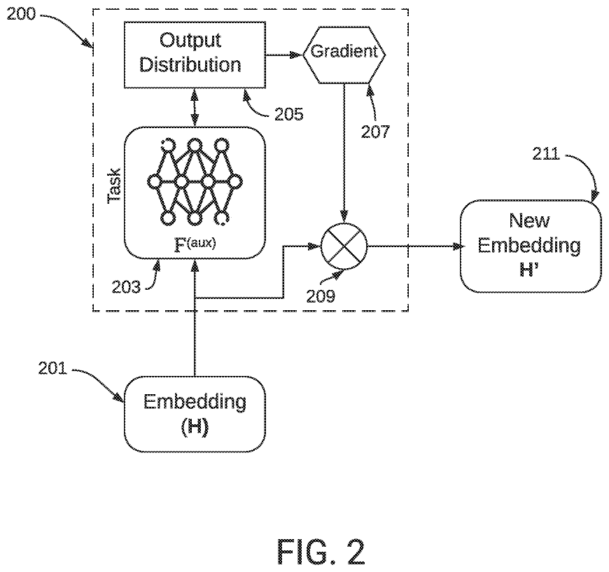

As discussed above, feature vectors 106 can be modified, e.g., by a task processor 108, in a manner that moves them toward a desired goal or outcome, such as a change/modification in semantic classification, e.g., a reduction in a safety score associated with the corresponding driving scene. For example, task processor 108 may be configured to modify feature vectors 106 according to a semantic classification distribution that is used to compute a gradient with respect to one or more of feature vectors 106. Modification of the feature vectors 106 by task processor 108 can result in a second set of feature vectors (or new feature embeddings H′) 110. For example, new feature embeddings 110 can describe deep features of newly generated driving data, e.g., including a new/synthetic driving scene. That is, new feature embeddings 110 can more accurately encode (or more closely reflect) the goal defined by task processor 108, i.e., the generation of driving data representing a driving scene with a reduced safety score, and/or that encodes an edge-case driving scenario. The new feature vectors 110 can be provided to a decoder model 112, for example, to reconstruct new feature vectors 110 into a driving data/driving scene format (e.g., a second driving scene). Safety scoring can then be performed by a discriminator model 114 to produce a safety score output 116, for example to validate that new feature vectors 110 have achieved the goal of task processor 108. Depending on task processor 108, the output safety score 116 for the second driving scene may be lower (or higher) than that of the first driving scene provided by input 102. In this manner, data generation engine 100 can be used to generate new and useful driving scene data, for example, that can be used to improve the testing and/or training of various AV systems. For example, data generation engine 100 can be used for generating useful edge-case driving scene data, e.g., that represents dangerous driving scenarios that would be rarely encountered during typical AV deployments. Further details regarding the role of task processor 108 are provided with respect to FIG. 2, below.

In particular, FIG. 2 illustrates a block diagram of a task processor 200 that is configured to facilitate the generation of synthetic driving scenarios. In practice, task processor 200 is configured to receive feature embeddings 201, which can include a plurality of feature vectors (or deep features) corresponding with some input data, e.g., driving data or driving scene data. Task model 203 can then use feature vectors 201 to determine an estimated output distribution 205. By way of example, if the task model 203 is configured to facilitate the generation of synthetic driving scenes that comport with some pre-define semantic classification (e.g., a target safety score), the output distribution 205 can represent safety scores corresponding with the received feature vectors 201. Using the output distribution 205, a gradient 207 can be calculated with respect to one or more of the feature vectors 201, e.g., to determine how to move/change the feature vectors 209 in order to generate modified/new feature vectors 211.

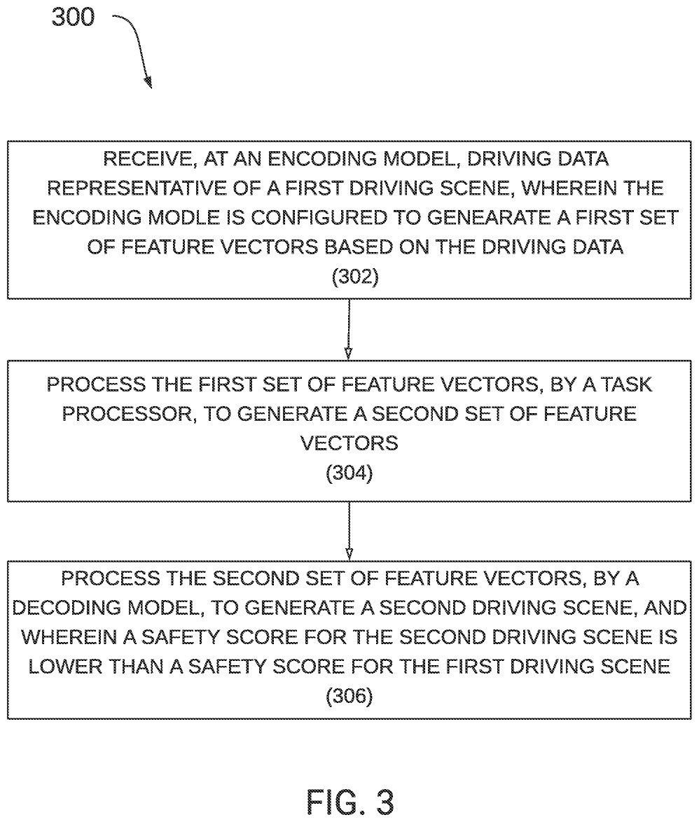

FIG. 3 illustrates a flow diagram of an example process 300 for performing synthetic scene generation, according to some aspects of the disclosed technology. In step 302, the process 300 includes, receiving, at an encoding model, driving data representative of a first driving scene, wherein the encoding model is configured to generate a first set of feature vectors based on the driving data.

In step 304, the process 300 includes, processing the first set of feature vectors, by a task processor, to generate a second set of feature vectors.

In step 306, the process 300 includes processing the second set of feature vectors, by a decoding model, to generate a second driving scene, and wherein a safety score for the second driving scene is lower than a safety score for the first driving scene.

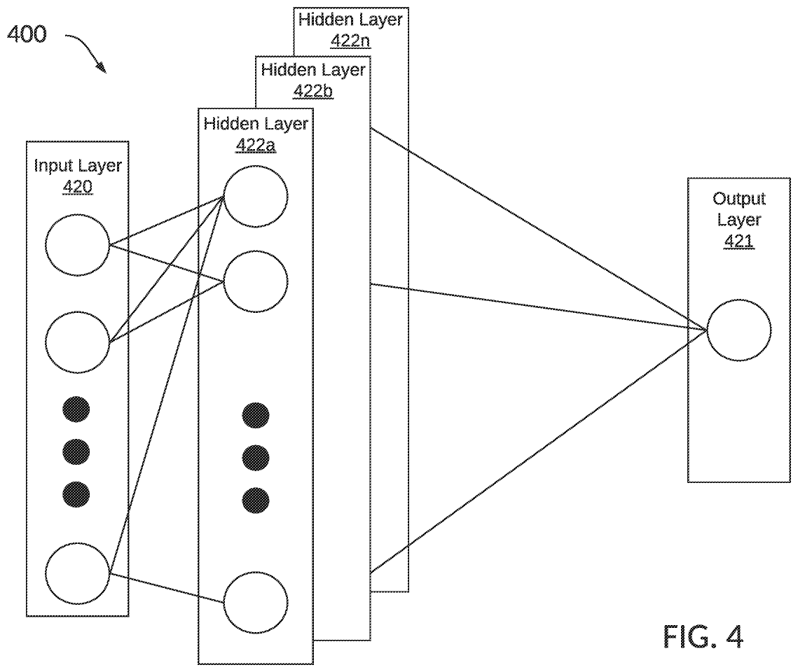

FIG. 4 is an illustrative example of a deep learning neural network 400 that can be implemented in a first-order unadversarial data generation engine of the disclosed technology. An input layer 420 includes input data. In one illustrative example, the input layer 420 can be configured to receive data (e.g., driving data or vehicle data) representative of a driving scene. By way of example, the driving data may include sensor data for one or more AV sensors that describe a scene encountered by the AV. By way of example, the scene may be represented by sensor data for one or more entities encountered by the capturing AV during its operation. The neural network 400 includes multiple hidden layers 422a, 422b, through 422n. The hidden layers 422a, 422b, through 422n include “n” number of hidden layers, where “n” is an integer greater than or equal to one. The number of hidden layers can be made to include as many layers as needed for the given application. The neural network 400 further includes an output layer 421 that provides an output resulting from the processing performed by the hidden layers 422a, 422b, through 422n.

The neural network 400 is a multi-layer neural network of interconnected nodes. Each node can represent a piece of information. Information associated with the nodes is shared among the different layers and each layer retains information as information is processed. In some cases, the neural network 400 can include a feed-forward network, in which case there are no feedback connections where outputs of the network are fed back into itself. In some cases, the neural network 400 can include a recurrent neural network, which can have loops that allow information to be carried across nodes while reading in input.

Information can be exchanged between nodes through node-to-node interconnections between the various layers. Nodes of the input layer 420 can activate a set of nodes in the first hidden layer 422a. For example, as shown, each of the input nodes of the input layer 420 is connected to each of the nodes of the first hidden layer 422a. The nodes of the first hidden layer 422a can transform the information of each input node by applying activation functions to the input node information. The information derived from the transformation can then be passed to and can activate the nodes of the next hidden layer 422b, which can perform their own designated functions. Example functions include convolutional, up-sampling, data transformation, and/or any other suitable functions. The output of the hidden layer 422b can then activate nodes of the next hidden layer, and so on. The output of the last hidden layer 422n can activate one or more nodes of the output layer 421, at which an output is provided. In some cases, while nodes (e.g., node 426) in the neural network 400 are shown as having multiple output lines, a node can have a single output and all lines shown as being output from a node represent the same output value.

In some cases, each node or interconnection between nodes can have a weight that is a set of parameters derived from the training of the neural network 400. Once the neural network 400 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 400 to be adaptive to inputs and able to learn as more and more data is processed.

Neural network 400 is pre-trained to process the features from the data in the input layer 420 using the different hidden layers 422a, 422b, through 422n in order to provide the output through the output layer 421. In some cases, the neural network 400 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training data until the neural network 400 is trained well enough so that the weights of the layers are accurately tuned.

A loss function can be used to analyze error in the output. Any suitable loss function definition can be used, such as a Cross-Entropy loss. Another example of a loss function includes the mean squared error (MSE), defined as

$$E\_total = \sum ( \frac{1}{2} {( target - output )}^{2} ) .$$

The loss can be set to be equal to the value of E_total. The goal of training is to minimize the amount of loss so that the predicted output is the same as the training label. The neural network 400 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=w_i−η dL/dW, where w denotes a weight, wi denotes the initial weight, and η denotes a learning rate. The learning rate can be set to any suitable value, with a high learning rate including larger weight updates and a lower value indicating smaller weight updates.

The neural network 400 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. The neural network 400 can include any other deep network other than a CNN, such as an autoencoder, a deep belief nets (DBNs), a Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

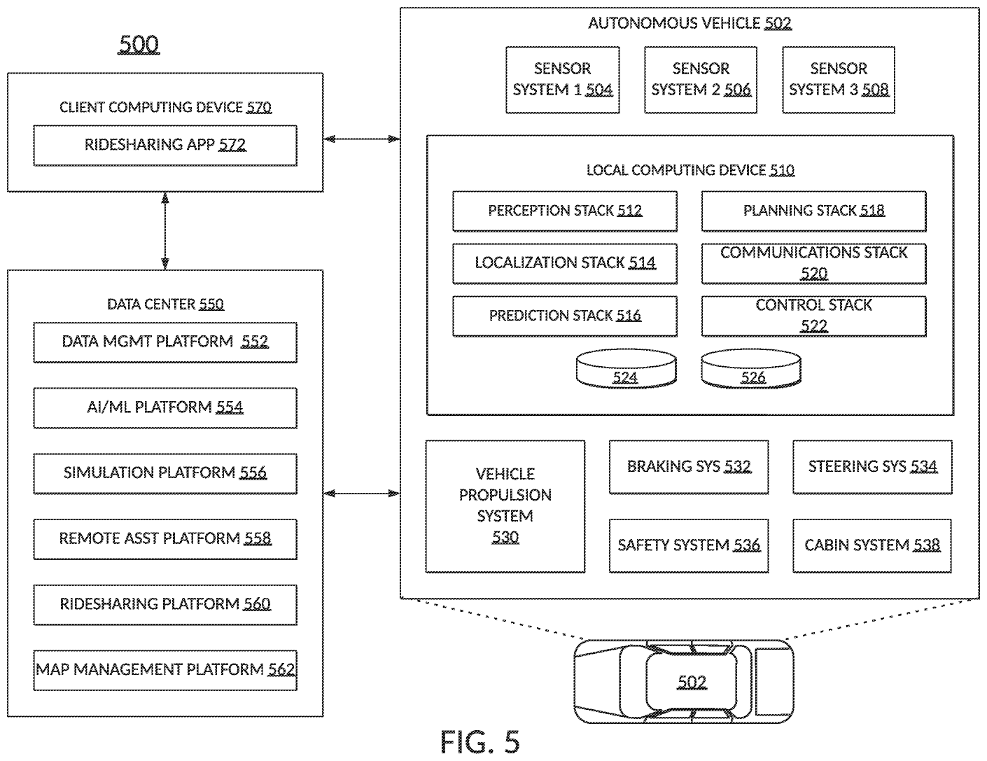

FIG. 5 illustrates an example of an AV management system 500. One of ordinary skill in the art will understand that, for the AV management system 500 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 500 includes an AV 502, a data center 150, and a client computing device 170. The AV 502, the data center 550, and the client computing device 570 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 502 can navigate roadways without a human driver based on sensor signals generated by multiple sensor systems 504, 506, and 508. The sensor systems 504-508 can include different types of sensors and can be arranged about the AV 502. For instance, the sensor systems 504-508 can comprise Inertial Measurement Units (IMUs), cameras (e.g., still image cameras, video cameras, etc.), optical sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 504 can be a camera system, the sensor system 506 can be a LIDAR system, and the sensor system 508 can be a RADAR system. Other embodiments may include any other number and type of sensors.

The AV 502 can also include several mechanical systems that can be used to maneuver or operate the AV 502. For instance, the mechanical systems can include a vehicle propulsion system 530, a braking system 532, a steering system 534, a safety system 536, and a cabin system 538, among other systems. The vehicle propulsion system 530 can include an electric motor, an internal combustion engine, or both. The braking system 532 can include an engine brake, brake pads, actuators, and/or any other suitable componentry configured to assist in decelerating the AV 502. The steering system 534 can include suitable componentry configured to control the direction of movement of the AV 502 during navigation. The safety system 536 can include lights and signal indicators, a parking brake, airbags, and so forth. The cabin system 538 can include cabin temperature control systems, in-cabin entertainment systems, and so forth. In some embodiments, the AV 502 might not include human driver actuators (e.g., steering wheel, handbrake, foot brake pedal, foot accelerator pedal, turn signal lever, window wipers, etc.) for controlling the AV 502. Instead, the cabin system 538 can include one or more client interfaces (e.g., Graphical User Interfaces (GUIs), Voice User Interfaces (VUIs), etc.) for controlling certain aspects of the mechanical systems 530-538.

The AV 502 can additionally include a local computing device 510 that is in communication with the sensor systems 504-508, the mechanical systems 530-538, the data center 550, and the client computing device 570, among other systems. The local computing device 510 can include one or more processors and memory, including instructions that can be executed by the one or more processors. The instructions can make up one or more software stacks or components responsible for controlling the AV 502; communicating with the data center 550, the client computing device 570, and other systems; receiving inputs from riders, passengers, and other entities within the AV's environment; logging metrics collected by the sensor systems 504-508; and so forth. In this example, the local computing device 510 includes a perception stack 512, a mapping and localization stack 514, a prediction stack 516, a planning stack 518, a communications stack 520, a control stack 522, an AV operational database 524, and an HD geospatial database 526, among other stacks and systems.

The perception stack 512 can enable the AV 502 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 504-508, the mapping and localization stack 514, the HD geospatial database 526, other components of the AV, and other data sources (e.g., the data center 550, the client computing device 570, third party data sources, etc.). The perception stack 512 can detect and classify objects and determine their current locations, speeds, directions, and the like. In addition, the perception stack 512 can determine the free space around the AV 502 (e.g., to maintain a safe distance from other objects, change lanes, park the AV, etc.). The perception stack 512 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 514 can determine the AV's position and orientation (pose) using different methods from multiple systems (e.g., GPS, IMUs, cameras, LIDAR, RADAR, ultrasonic sensors, the HD geospatial database 526, etc.). For example, in some embodiments, the AV 502 can compare sensor data captured in real-time by the sensor systems 504-508 to data in the HD geospatial database 526 to determine its precise (e.g., accurate to the order of a few centimeters or less) position and orientation. The AV 502 can focus its search based on sensor data from one or more first sensor systems (e.g., GPS) by matching sensor data from one or more second sensor systems (e.g., LIDAR). If the mapping and localization information from one system is unavailable, the AV 502 can use mapping and localization information from a redundant system and/or from remote data sources.

The prediction stack 516 can receive information from the localization stack 514 and objects identified by the perception stack 512 and predict a future path for the objects. In some embodiments, the prediction stack 516 can output several likely paths that an object is predicted to take along with a probability associated with each path. For each predicted path, the prediction stack 516 can also output a range of points along the path corresponding to a predicted location of the object along the path at future time intervals along with an expected error value for each of the points that indicates a probabilistic deviation from that point.

The planning stack 518 can determine how to maneuver or operate the AV 502 safely and efficiently in its environment. For example, the planning stack 518 can receive the location, speed, and direction of the AV 502, geospatial data, data regarding objects sharing the road with the AV 502 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 502 from one point to another and outputs from the perception stack 512, localization stack 514, and prediction stack 516. The planning stack 518 can determine multiple sets of one or more mechanical operations that the AV 502 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 518 can select from multiple backup plans to carry out. For example, while preparing to change lanes to turn right at an intersection, another vehicle may aggressively cut into the destination lane, making the lane change unsafe. The planning stack 518 could have already determined an alternative plan for such an event. Upon its occurrence, it could help direct the AV 502 to go around the block instead of blocking a current lane while waiting for an opening to change lanes.

The control stack 522 can manage the operation of the vehicle propulsion system 530, the braking system 532, the steering system 534, the safety system 536, and the cabin system 538. The control stack 522 can receive sensor signals from the sensor systems 504-508 as well as communicate with other stacks or components of the local computing device 510 or a remote system (e.g., the data center 550) to effectuate operation of the AV 502. For example, the control stack 522 can implement the final path or actions from the multiple paths or actions provided by the planning stack 518. This can involve turning the routes and decisions from the planning stack 518 into commands for the actuators that control the AV's steering, throttle, brake, and drive unit.

The communications stack 520 can transmit and receive signals between the various stacks and other components of the AV 502 and between the AV 502, the data center 550, the client computing device 570, and other remote systems. The communications stack 520 can enable the local computing device 510 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 520 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 526 can store HD maps and related data of the streets upon which the AV 502 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 524 can store raw AV data generated by the sensor systems 504-508, stacks 512-522, and other components of the AV 502 and/or data received by the AV 502 from remote systems (e.g., the data center 550, the client computing device 570, etc.). In some embodiments, the raw AV data can include HD LIDAR point cloud data, image data, RADAR data, GPS data, and other sensor data that the data center 550 can use for creating or updating AV geospatial data or for creating simulations of situations encountered by AV 502 for future testing or training of various machine learning algorithms that are incorporated in the local computing device 510.

The data center 550 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 550 can include one or more computing devices remote to the local computing device 510 for managing a fleet of AVs and AV-related services. For example, in addition to managing the AV 502, the data center 550 may also support a ridesharing service, a delivery service, a remote/roadside assistance service, street services (e.g., street mapping, street patrol, street cleaning, street metering, parking reservation, etc.), and the like.

The data center 550 can send and receive various signals to and from the AV 502 and the client computing device 570. These signals can include sensor data captured by the sensor systems 504-508, roadside assistance requests, software updates, ridesharing pick-up and drop-off instructions, and so forth. In this example, the data center 550 includes a data management platform 552, an Artificial Intelligence/Machine Learning (AI/ML) platform 554, a simulation platform 556, a remote assistance platform 558, and a ridesharing platform 560, and a map management platform 562, among other systems.

The data management platform 552 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 550 can access data stored by the data management platform 552 to provide their respective services.

The AI/ML platform 554 can provide the infrastructure for training and evaluating machine learning algorithms for operating the AV 502, the simulation platform 556, the remote assistance platform 558, the ridesharing platform 560, the map management platform 562, and other platforms and systems. Using the AI/ML platform 554, data scientists can prepare data sets from the data management platform 552; select, design, and train machine learning models; evaluate, refine, and deploy the models; maintain, monitor, and retrain the models; and so on.

The simulation platform 556 can enable testing and validation of the algorithms, machine learning models, neural networks, and other development efforts for the AV 502, the remote assistance platform 558, the ridesharing platform 560, the map management platform 562, and other platforms and systems. The simulation platform 556 can replicate a variety of driving environments and/or reproduce real-world scenarios from data captured by the AV 502, including rendering geospatial information and road infrastructure (e.g., streets, lanes, crosswalks, traffic lights, stop signs, etc.) obtained from a cartography platform (e.g., map management platform 562); modeling the behavior of other vehicles, bicycles, pedestrians, and other dynamic elements; simulating inclement weather conditions, different traffic scenarios; and so on.

The remote assistance platform 558 can generate and transmit instructions regarding the operation of the AV 502. For example, in response to an output of the AI/ML platform 554 or other system of the data center 550, the remote assistance platform 558 can prepare instructions for one or more stacks or other components of the AV 502.

Ridesharing platform 560 can interact with a customer of a ridesharing service via a ridesharing application 572 executing on the client computing device 570. The client computing device 570 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 572. The client computing device 570 can be a customer's mobile computing device or a computing device integrated with the AV 502 (e.g., the local computing device 510). The ridesharing platform 560 can receive requests to pick up or drop off from the ridesharing application 572 and dispatch the AV 502 for the trip.

Map management platform 562 can provide a set of tools for the manipulation and management of geographic and spatial (geospatial) and related attribute data. The data management platform 552 can receive LIDAR point cloud data, image data (e.g., still image, video, etc.), RADAR data, GPS data, and other sensor data (e.g., raw data) from one or more AVs 502, Unmanned Aerial Vehicles (UAVs), satellites, third-party mapping services, and other sources of geospatially referenced data. The raw data can be processed, and map management platform 562 can render base representations (e.g., tiles (2D), bounding volumes (3D), etc.) of the AV geospatial data to enable users to view, query, label, edit, and otherwise interact with the data. Map management platform 562 can manage workflows and tasks for operating on the AV geospatial data. Map management platform 562 can control access to the AV geospatial data, including granting or limiting access to the AV geospatial data based on user-based, role-based, group-based, task-based, and other attribute-based access control mechanisms. Map management platform 562 can provide version control for the AV geospatial data, such as to track specific changes that (human or machine) map editors have made to the data and to revert changes when necessary. Map management platform 562 can administer release management of the AV geospatial data, including distributing suitable iterations of the data to different users, computing devices, AVs, and other consumers of HD maps. Map management platform 562 can provide analytics regarding the AV geospatial data and related data, such as to generate insights relating to the throughput and quality of mapping tasks.

In some embodiments, the map viewing services of map management platform 562 can be modularized and deployed as part of one or more of the platforms and systems of the data center 550. For example, the AI/ML platform 554 may incorporate the map viewing services for visualizing the effectiveness of various object detection or object classification models, the simulation platform 556 may incorporate the map viewing services for recreating and visualizing certain driving scenarios, the remote assistance platform 558 may incorporate the map viewing services for replaying traffic incidents to facilitate and coordinate aid, the ridesharing platform 560 may incorporate the map viewing services into the client application 572 to enable passengers to view the AV 502 in transit en route to a pick-up or drop-off location, and so on.

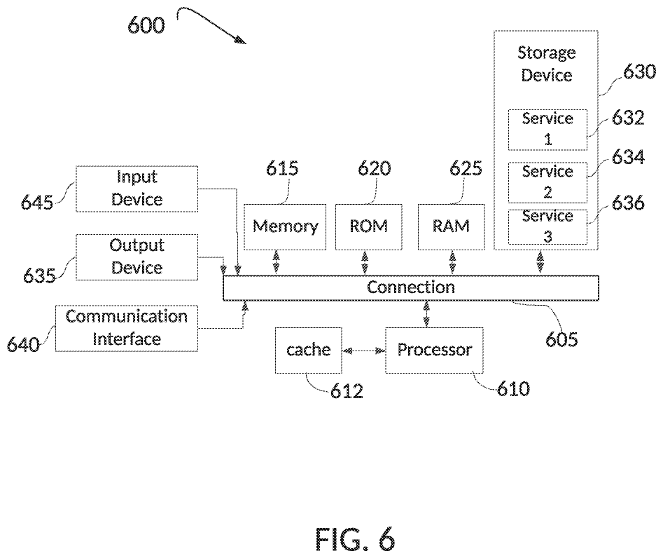

FIG. 6 illustrates an example apparatus (e.g., a processor-based system) with which some aspects of the subject technology can be implemented. For example, processor-based system 600 can be any computing device making up internal computing system 610, remote computing system 650, a passenger device executing the rideshare app 670, internal computing device 630, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the functions for which the component is described. In some embodiments, the components can be physical or virtual devices.

Example system 600 includes at least one processing unit (CPU or processor) 610 and connection 605 that couples various system components including system memory 615, such as read-only memory (ROM) 620 and random-access memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communication interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L6), resistive random-access memory (RRAM/ReRAM), phase change memory (PCM), spin transfer torque RAM (STT-RAM), another memory chip or cartridge, and/or a combination thereof.

Storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as processor 610, connection 605, output device 635, etc., to carry out the function.

As understood by those of skill in the art, machine-learning based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

Illustrative aspects of the disclosure include:

Aspect 1: An apparatus for generating a synthetic driving scene, comprising: at least one memory; and at least one processor coupled to the at least one memory, the at least one processor configured to: receive, at an encoding model, driving data representative of a first driving scene, wherein the encoding model is configured to generate a first set of feature vectors based on the driving data; process the first set of feature vectors, by a task processor, to generate a second set of feature vectors; and process the second set of feature vectors, by a decoding model, to generate a second driving scene, and wherein a safety score for the second driving scene is lower than a safety score for the first driving scene.

Aspect 2: The apparatus of aspect 1, wherein the at least one processor is further configured to: provide the second driving scene to a discriminator model configured to perform safety score classification, wherein the discriminator model is a machine-learning model; and receive, from the discriminator model, the safety score for the second driving scene.

Aspect 3: the apparatus of any of aspects 1-2, wherein the task processor comprises a task model configured to modify one or more of the first set of feature vectors to achieve a lower safety score.

Aspect 4: The apparatus of any of aspects 1-3, wherein the task model is a machine-learning model, and wherein one or more weights associated with one or more layers of the task model are configured to be updated using an objective loss function of the decoding model.

Aspect 5: The apparatus of any of aspects 1-4, wherein one or more weights associated with one or more layers of the encoding model are configured to be updated by a loss function of the task model.

Aspect 6: The apparatus of any of aspects 1-5, wherein the encoding model and the decoding model are machine-learning models.

Aspect 7: The apparatus of any of aspects 1-6, wherein the driving data comprises sensor data collected by one or more sensors of an autonomous vehicle (AV).

Aspect 8: A computer-implemented method for generating a synthetic driving scene, comprising: receiving, at an encoding model, driving data representative of a first driving scene, wherein the encoding model is configured to generate a first set of feature vectors based on the driving data; processing the first set of feature vectors, by a task processor, to generate a second set of feature vectors; processing the second set of feature vectors, by a decoding model, to generate a second driving scene, and wherein a safety score for the second driving scene is lower than a safety score for the first driving scene.

Aspect 9: The computer-implemented method of aspect 8, further comprising: providing the second driving scene to a discriminator model configured to perform safety score classification, wherein the discriminator model is a machine-learning model; and receiving, from the discriminator model, the safety score for the second driving scene.

Aspect 10: The computer-implemented method of any of aspects 8-9, wherein the task processor comprises a task model configured to modify one or more of the first set of feature vectors to achieve a lower safety score.

Aspect 11: The computer-implemented method of any of aspects 8-10, wherein the task model is a machine-learning model, and wherein one or more weights associated with one or more layers of the task model are configured to be updated using an objective loss function of the decoding model.

Aspect 12: The computer-implemented method of any of aspects 8-11, wherein one or more weights associated with one or more layers of the encoding model are configured to be updated by a loss function of the task model.

Aspect 13: The computer-implemented method of any of aspects 8-12, wherein the encoding model and the decoding model are machine-learning models.

Aspect 14: The computer-implemented method of any of aspects 8-13, wherein the driving data comprises sensor data collected by one or more sensors of an autonomous vehicle (AV).

Aspect 15: A non-transitory computer-readable storage medium comprising at least one instruction for causing a computer or processor to: receive, at an encoding model, driving data representative of a first driving scene, wherein the encoding model is configured to generate a first set of feature vectors based on the driving data; process the first set of feature vectors, by a task processor, to generate a second set of feature vectors; and process the second set of feature vectors, by a decoding model, to generate a second driving scene, and wherein a safety score for the second driving scene is lower than a safety score for the first driving scene.

Aspect 16: The non-transitory computer-readable storage medium of aspect 15, wherein the at least one instruction is further configured to cause the processor to: provide the second driving scene to a discriminator model configured to perform safety score classification, wherein the discriminator model is a machine-learning model; and receive, from the discriminator model, the safety score for the second driving scene.

Aspect 17: The non-transitory computer-readable storage medium of any of aspects 15-16, wherein the task processor comprises a task model configured to modify one or more of the first set of feature vectors to achieve a lower safety score.

Aspect 18: The non-transitory computer-readable storage medium of any of aspects 15-17, wherein the task model is a machine-learning model, and wherein one or more weights associated with one or more layers of the task model are configured to be updated using an objective loss function of the decoding model.

Aspect 19: The non-transitory computer-readable storage medium of aspects 15-18, wherein one or more weights associated with one or more layers of the encoding model are configured to be updated by a loss function of the task model.

Aspect 20: The non-transitory computer-readable storage medium of aspects 15-19, wherein the encoding model and the decoding model are machine-learning models.

What is claimed is:

1. An apparatus for generating a synthetic driving scene, comprising:
at least one memory; and
at least one processor coupled to the at least one memory, the at least one processor configured to:
receive, at an encoding model, driving data representative of a first driving scene, wherein the encoding model is configured to generate a first set of feature vectors based on the driving data;
process the first set of feature vectors, by a task processor, to generate a second set of feature vectors; and
process the second set of feature vectors, by a decoding model, to generate a second driving scene, and wherein a safety score for the second driving scene is lower than a safety score for the first driving scene.

2. The apparatus of claim 1, wherein the at least one processor is further configured to:
provide the second driving scene to a discriminator model configured to perform safety score classification, wherein the discriminator model is a machine-learning model; and
receive, from the discriminator model, the safety score for the second driving scene.

3. The apparatus of claim 1, wherein the task processor comprises a task model configured to modify one or more of the first set of feature vectors to achieve a lower safety score.

4. The apparatus of claim 3, wherein the task model is a machine-learning model, and wherein one or more weights associated with one or more layers of the task model are configured to be updated using an objective loss function of the decoding model.

5. The apparatus of claim 1, wherein one or more weights associated with one or more layers of the encoding model are configured to be updated by a loss function of the task model.

6. The apparatus of claim 1, wherein the encoding model and the decoding model are machine-learning models.

7. The apparatus of claim 1, wherein the driving data comprises sensor data collected by one or more sensors of an autonomous vehicle (AV).

8. A computer-implemented method for generating a synthetic driving scene, comprising:
receiving, at an encoding model, driving data representative of a first driving scene, wherein the encoding model is configured to generate a first set of feature vectors based on the driving data;
processing the first set of feature vectors, by a task processor, to generate a second set of feature vectors;
processing the second set of feature vectors, by a decoding model, to generate a second driving scene, and wherein a safety score for the second driving scene is lower than a safety score for the first driving scene.

9. The computer-implemented method of claim 8, further comprising:
providing the second driving scene to a discriminator model configured to perform safety score classification, wherein the discriminator model is a machine-learning model; and
receiving, from the discriminator model, the safety score for the second driving scene.

10. The computer-implemented method of claim 8, wherein the task processor comprises a task model configured to modify one or more of the first set of feature vectors to achieve a lower safety score.

11. The computer-implemented method of claim 8, wherein the task model is a machine-learning model, and wherein one or more weights associated with one or more layers of the task model are configured to be updated using an objective loss function of the decoding model.

12. The computer-implemented method of claim 8, wherein one or more weights associated with one or more layers of the encoding model are configured to be updated by a loss function of the task model.

13. The computer-implemented method of claim 8, wherein the encoding model and the decoding model are machine-learning models.

14. The computer-implemented method of claim 8, wherein the driving data comprises sensor data collected by one or more sensors of an autonomous vehicle (AV).

15. A non-transitory computer-readable storage medium comprising at least one instruction for causing a computer or processor to:
receive, at an encoding model, driving data representative of a first driving scene, wherein the encoding model is configured to generate a first set of feature vectors based on the driving data;
process the first set of feature vectors, by a task processor, to generate a second set of feature vectors; and
process the second set of feature vectors, by a decoding model, to generate a second driving scene, and wherein a safety score for the second driving scene is lower than a safety score for the first driving scene.

16. The non-transitory computer-readable storage medium of claim 15, wherein the at least one instruction is further configured to cause the processor to:
provide the second driving scene to a discriminator model configured to perform safety score classification, wherein the discriminator model is a machine-learning model; and
receive, from the discriminator model, the safety score for the second driving scene.

17. The non-transitory computer-readable storage medium of claim 15, wherein the task processor comprises a task model configured to modify one or more of the first set of feature vectors to achieve a lower safety score.

18. The non-transitory computer-readable storage medium of claim 17, wherein the task model is a machine-learning model, and wherein one or more weights associated with one or more layers of the task model are configured to be updated using an objective loss function of the decoding model.

19. The non-transitory computer-readable storage medium of claim 15, wherein one or more weights associated with one or more layers of the encoding model are configured to be updated by a loss function of the task model.

20. The non-transitory computer-readable storage medium of claim 15, wherein the encoding model and the decoding model are machine-learning models.
